(19) United States
(12) Patent Application Publication
(10) Pub. No.: US 2014/0245905 A1
(43) Pub. Date: Sep. 4, 2014

(54) LENS AND ADHESIVE ASSEMBLY, AND COOKING APPLIANCE INCLUDING A LENS AND ADHESIVE ASSEMBLY

(71) Applicant: Electrolux Home Products, Inc., Charlotte, NC (US)

(72) Inventor: Constantin Lamasanu, Le Gardeur (CA)

(21) Appl. No.: 14/195,031

(22) Filed: Mar. 3, 2014

Related U.S. Application Data
(60) Provisional application No. 61/771,541, filed on Mar. 1, 2013.

(51) Int. Cl. A47J 36/34

(52) U.S. Cl. CPC A47J 36/34
USPC 99/357

(57) ABSTRACT

Provided is a cooking apparatus that includes a cooking element operable to heat a cooking vessel, and an illumination device that is illuminated to convey information about an operational aspect of the cooking element to a user. A body panel of the cooking apparatus defines an aperture through which light emitted by the illumination device exits the cooking apparatus. A lens is coupled to the body panel adjacent to the aperture to interfere with entry of foreign matter into an interior of the cooking apparatus through the aperture. The lens includes a protruding region that extends from within the interior of the cooking apparatus at least partially into the aperture, and a flange region that extends laterally outward, generally away from the protruding region and is coupled to an underside of the body panel.

### CROSS-REFERENCE TO RELATED APPLICATIONS

This application claims the benefit of U.S. Provisional Application No. 61/771,541, filed Mar. 1, 2013, which is incorporated in its entirety herein by reference.

### BACKGROUND OF THE INVENTION

1. Field of the Invention

This application relates generally to a cooking appliance and, more specifically, a lens and method of assembling a lens assembly for a cooking appliance that protects against the intrusion of liquids into an interior of the cooking appliance via the lens assembly.

2. Description of Related Art

Conventional lens assemblies have utilized a pre-formed, rubber gasket that is to be installed on the perimeter of a lens before the lens is installed. With the gasket in place on the lens, the lens/gasket assembly would then be positioned in an aperture in a trim piece. Installation of the rubber gasket, however, required the gasket to be precisely installed between the lens and the trim piece, otherwise liquids could potentially pass there between and gain entry to an interior of the cooking appliance, where such liquids could potentially damage electric circuitry. To interfere with the intrusion of liquids, a strong compressive force squeezing the gasket between the lens and the trim piece was required. But relaxation of the gasket material caused the compressive force to deteriorate over time, again creating the risk that liquids could pass between the lens and the trim piece.

### BRIEF SUMMARY OF THE INVENTION

According to one aspect, the subject application involves a cooking apparatus that includes a cooking element operable to heat a cooking vessel, and an illumination device disposed within the cooking apparatus that is to be illuminated to convey information about an operational aspect of the cooking element to a user. A body panel defines an aperture through which light emitted by the illumination device exits the cooking apparatus. A lens is coupled to the body panel adjacent to the aperture to interfere with entry of foreign matter into an interior of the cooking apparatus through the aperture. The lens includes a protruding region that extends from within the interior of the cooking apparatus at least partially into the aperture, and a flange region that extends laterally outward, generally away from the protruding region and is coupled to an underside of the body panel.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows a perspective view of a cooking appliance in the form of a gas range with a substantially-horizontal control panel including a plurality of lenses through which information relating to an operational aspect of the cooking appliance can be conveyed to a user;

FIG. 2 shows a perspective view of a cooking appliance in the form of an electric cooktop with a substantially-horizontal control panel including a plurality of lenses through which information relating to an operational aspect of the cooking appliance can be conveyed to a user;

FIG. 3 is an enlarged front view of a lens installed on a body panel of the cooking appliance shown in FIG. 2;

FIG. 4 is a perspective view of an inward-facing surface of a lens that is to be installed on a panel or other portion of a cooking appliance, wherein the inward-facing surface is exposed to an internal region of the cooking appliance once installed;

FIG. 5 is a perspective view of an outward-facing surface surrounded by a flange provide to a lens that is to be installed on a panel or other portion of a cooking appliance, wherein the outward-facing surface is exposed externally of the cooking appliance, to an ambient environment in which the cooking device is located, once installed;

FIG. 6 is a bottom view of a body panel on which a plurality of lenses have been installed such that a protruding region of the lens extends at least partially through an aperture defined by the body panel;

FIG. 7 is a sectional view of the lens installed on the body panel, taken along line 7-7 in FIG. 3; and

FIG. 8 is a perspective view of a printed circuit board coupled to an underside of a body panel with at least one standoff extending between the printed circuit board and each lens installed on the body panel to apply a biasing force that urges the plurality of lenses generally toward the underside of the body panel.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

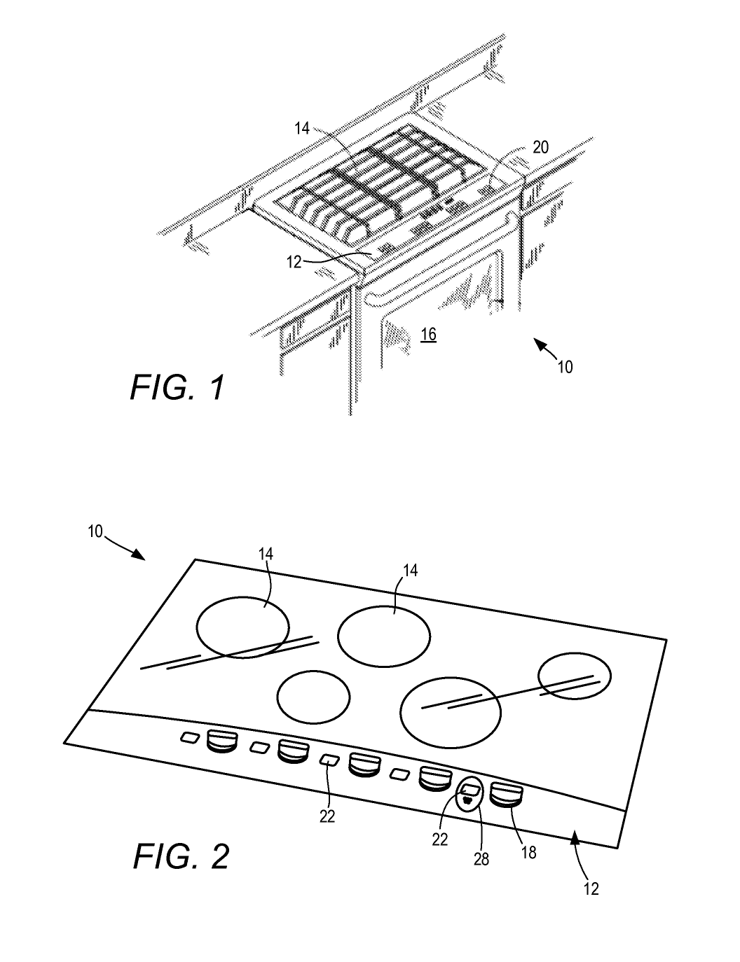

An illustrative embodiment of a cooking apparatus 10 is shown in FIGS. 1 and 2. For the embodiment shown in FIG. 1, the cooking apparatus 10 is a slide-in gas range. The cooking apparatus 10 includes at least one, and optionally a plurality of cooking elements 14 that are each independently operable to heat a cooking vessel supported above the respective cooking elements 14. Examples of the cooking elements 14 include, but are not limited to, an electric cooktop burner, an inductive cooktop burner, a gas cooktop burner, and any other device provided to a cooking appliance that can be utilized to heat a cooking vessel such as a pot, pan, dish, etc . . . for food preparation. Further, the embodiment of the cooking apparatus 10 shown in FIG. 1 includes an oven 16 in which food can be baked and broiled. For such embodiments, other examples of the cooking element include, but are not limited to an oven bake element, and an oven broil element.

FIG. 2 shows an alternate embodiment of the cooking apparatus 10 in the form of an electric cooktop. The cooking elements 14 of such an embodiment of a cooking apparatus 10 includes at least one cooktop surface element such as an electric coil burner, an inductive burner, or a combination thereof Cooktops such as that shown in FIG. 2 include a limited set of cooking elements 14 on which pots, pans, and other cooking vessels can be placed to be heated by those cooking elements 14, and lack the underlying oven 16 shown in FIG. 1.

The embodiments of the cooking apparatus 10 appearing in FIGS. 1 and 2 also include a substantially-horizontal body panel 12 at which input devices such as knobs 18, buttons 20, etc . . . are accessible by the user to control operation of the cooking elements 14. Although the body panel 12 is shown in FIGS. 1 and 2 as a control panel provided with various input devices, alternate embodiments of the body panel 12 include any substantially-planar surface, which can be an outwardly-exposed surface that is generally flat, without intended undulations or other significant elevation changes created by design, that is devoid of input devices. For such embodiments, the input devices can be located elsewhere on the cooking apparatus 10.

Regardless of whether the body panel 12 is also a control panel including the input devices 18, 20, the body panel 12 can be substantially horizontal. A substantially horizontal body panel 12 includes a surface with an orientation, other than vertical, allowing a liquid encountered during food preparation in a kitchen to be dropped or splashed. Such surfaces may allow the liquid thereon to travel along the surface, possibly encountering one or more lenses 22 provided to the body panel 12 along the way. However, the body panel 12 is not so limited, and can encompass vertically-oriented body panels 12 also including at least one of the lenses 22 described in detail below.

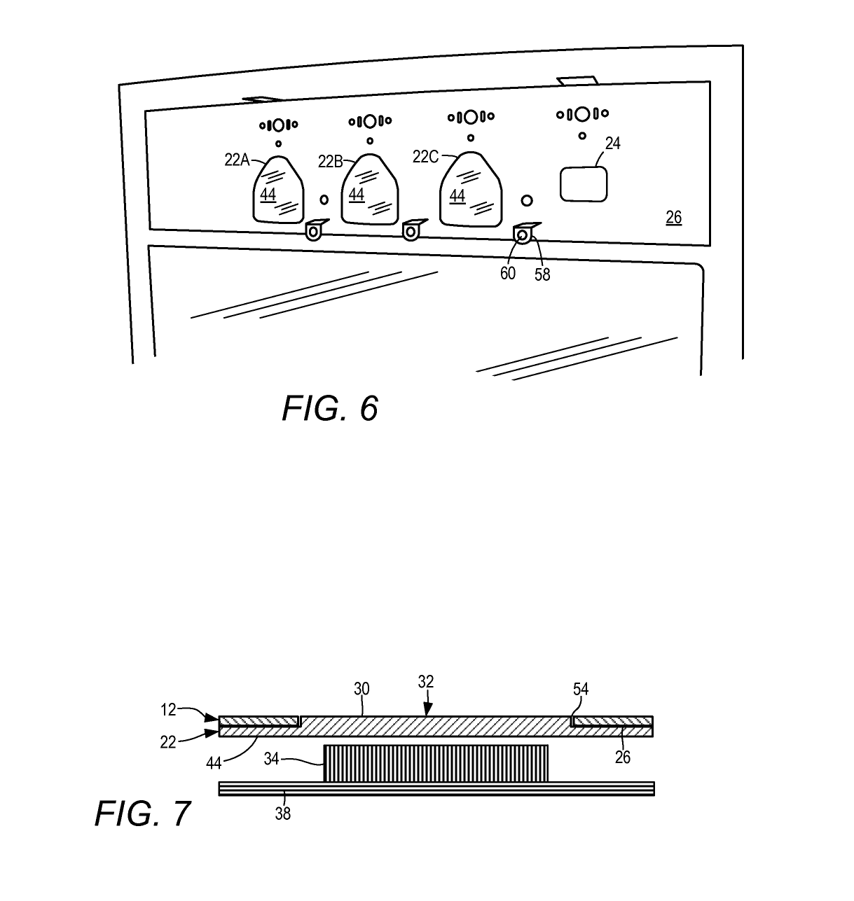

FIG. 6 shows a bottom view of the underside 26 of a body panel 12 to be installed on a cooking apparatus 10. The body panel 12 defines a plurality of apertures 24 where lenses 22 are to be installed. A plurality of lenses 22A, 22B, 22C are shown installed on the underside 26 of the body panel 12 adjacent to three of the apertures 24 in FIG. 6, while a fourth aperture 24 remains unconcealed by a lens that has yet to be installed. Each aperture 24 can be formed by stamping a hole of the desired shape and size in a sheet of metallic material, although body panels 12 formed according to other methods and formed from other materials are also encompassed by the scope of the present disclosure. According to alternate embodiments, the material of the body panel 12 defining the aperture 24 can optionally include a bent, or otherwise shaped portion to establish a vertical wall defining a depth of the aperture 24.

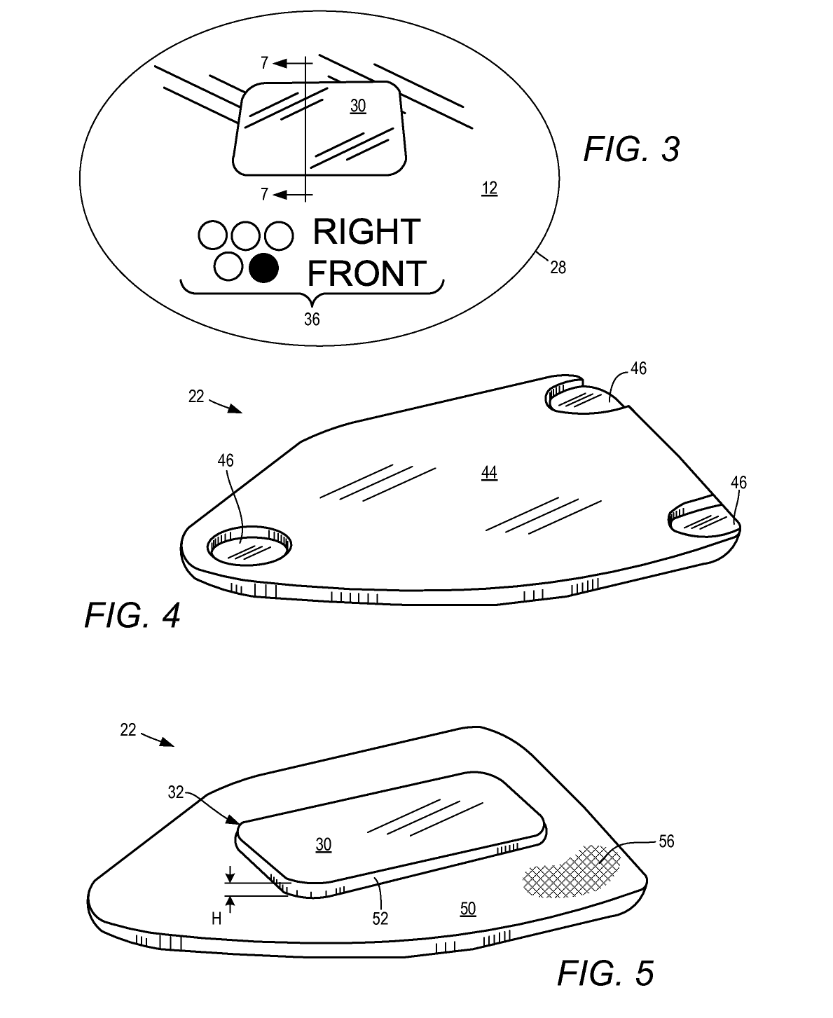

FIG. 3 is zoomed-in view of a sub-region 28 of the outwardly-exposed surface of the body panel 12 encircled in FIG. 2. The sub-region 28 includes a lens 22 coupled to the underside 26 of the body panel 12 of the cooking apparatus 10, as observed by a user standing in front of the cooking apparatus 10. Descriptive text and/or graphic 36 can optionally be applied to provide context to information conveyed to a user through the lens 22 as described herein. In FIG. 3, this descriptive text and graphic 36 identify the “RIGHT FRONT” cooktop burner as the cooking element 14 to which the information conveyed to the user through the lens 22 pertains. A substantially-planar, outward-facing surface 30 provided to a protruding region 32 (FIG. 5) of the lens 22 is positioned at approximately the same elevation as the surrounding portion of the body panel 12. Installed in this manner, the outward-facing surface 30 of the lens 22 and the surrounding portions of the body panel 12 have the appearance of a smooth, uninterrupted and planar surface.

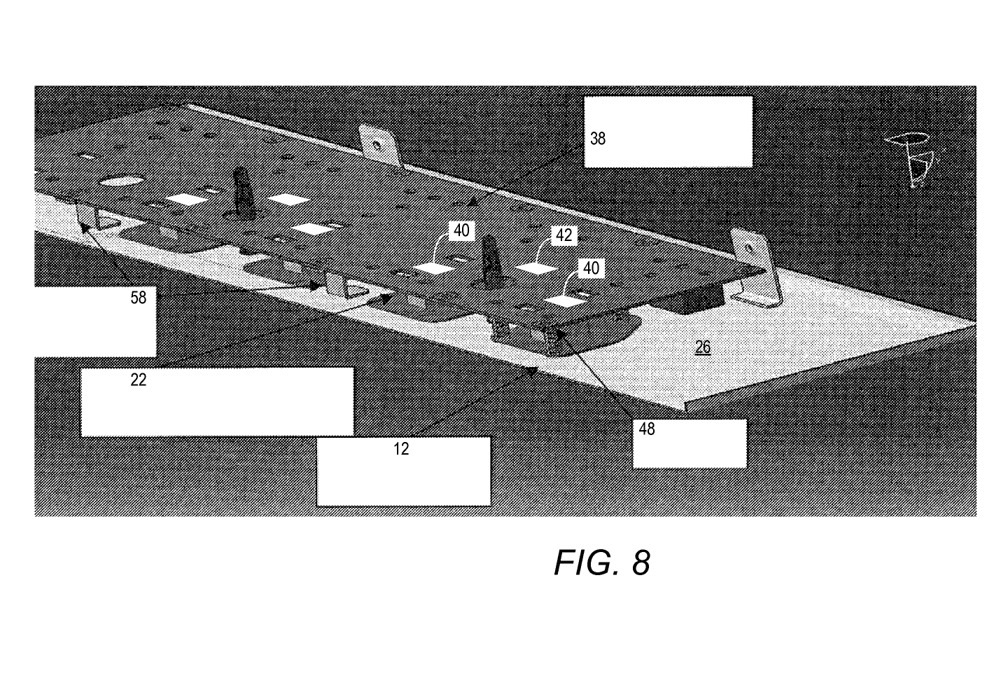

When observed from the vantage point of FIG. 3, at least the protruding region 32 including the outward-facing surface 30 transmits light from an underlying illumination device 34 (FIG. 7) that is illuminated to convey information about an operational aspect of the cooking apparatus 10 to the user. For instance, with reference to FIG. 7, the illumination device 34 can be separated from the underside 26 of the body panel 12 by the lens 22. According to such an embodiment, the illumination device 34 is supported by a printed circuit board (“PCB”) 38 with electric circuitry 40, schematically depicted in FIG. 8, for controlling operation of the illumination device 34, and optionally also electric circuitry 42 responsive to a command entered by the user through manipulation of one or more of the input devices 18, 20 to control operation of the cooking element 14 or other feature of the cooking apparatus 10.

Opposite surfaces of the lens 22 are shown in FIGS. 4 and 5. The inward-facing surface 44 of the lens 22 in FIG. 4 that is to face an interior of the cooking apparatus 10 while the lens 22 is installed on the underside of the body panel 12 or other portion of an operational cooking appliance 10. As shown, the inward-facing surface 44 includes at least one, and optionally a plurality of seats 46 that each cooperate with a brace such as a standoff 48, as shown in FIG. 8, that extends between the lens 22 and another portion of the cooking apparatus 10. In FIG. 8, the standoffs 48 extend between the seats 46 provided to the lenses 22 and the PCB 38 as described in detail below.

Each seat 46 can be independently formed to include a recess that extends into the inward-facing surface 44, or a protrusion that extends outwardly, away from the inward-facing surface 44. Other than the seats 46, the inward-facing surface 44 can optionally be a planar surface, formed at least in part from a light transmitting material that allows light emitted by the illumination device 34 to be transmitted through the lens 22 and out into the external environment of the cooking apparatus 10.

FIG. 5 shows the outward-facing surface 30 of the lens 22 as the top of a plateau formed by the protruding region 32 extending upwardly from a base portion that forms a flange 50 surrounding the protruding region 32. An external periphery 52 of the protruding region 32 is approximately the same as an internal periphery of the aperture 24 into which the protruding region 32 of the lens 22 is to extend. At least the protruding region 32 is formed from the light transmitting material to allow light emitted by the underlying illumination device 34 to be displayed through the lens 22 to the user in the external environment of the cooking apparatus 10. Embodiments of the lens 22 include the protruding region 32 and the surrounding flange 50 integrally formed as a monolithic structure from the same light transmitting material. Alternate embodiments of the lens 22, however, include a protruding region 32 and a region of the base portion vertically aligned with the protruding region 32 formed from the light transmitting material, while the laterally extending portions forming the flange 50 are formed from a different, generally opaque material.

The light transmitting material can optionally filter certain wavelengths of light emitted by the illuminating device 34, or otherwise alter the appearance of such light observed by the user through the lens 22. For example, the illuminating device 34 can optionally emit white light, but the light transmitting material through which this light is transmitted can filter certain wavelengths of light other than red, so the user observes the light transmitted through the lens 22 as red light.

The flange 50 extends a suitable distance laterally outward to be coupled to the underside 26 of the body panel 12. An adhesive 56 such as a double-sided adhesive tape with a release film or an adhesive coating with a release film, for example, can be applied to a surface of the flange 50 that is to be adhered to the underside 26 of the body panel 12. The release film protects the adhesive from foreign debris until a time when the lens 22 is to be installed on the body panel 12, at which time the release film is removed and the lens 22 pressed against the underside 26 of the body panel 12 so the adhesive couples the lens 22 to the body panel 12.

When coupled to the body panel 12, the flange can optionally form a water-tight seal with the body panel 12 about the periphery of the protruding region 32. The adhesive 56 can be applied to substantially the entire surface of the flange 50 that is to be adhered to the underside 26 of the body panel 12, fully surrounding the protruding region to ensure a water-tight seal entirely around the protruding region 32. This water-tight seal prevents a liquid spilled on the body panel 12, for example, from reaching the electric circuitry 40, 42 within the interior of the cooking apparatus 10 through a space 54 (FIG. 7) between the external periphery 52 of the protruding region 32 and the interior periphery of the aperture 24.

The protruding region 32 extends a suitable height H to extend at least partially through the aperture 24 defined by the body panel 12 when the lens 22 is adhesively or otherwise installed on the underside 26 of the body panel 12. As shown in FIG. 7, the adhesive-coated surface of the flange 50 is adhered to the underside 26 of the body panel 12. The height H of the protruding region 32 with the outward-facing surface 30 is suitable to align the outward-facing surface 30 in a substantially planar relationship to the exposed surface of the body panel 12.

The illuminating device 34 supported by the PCB 38 is arranged beneath the protruding portion 32 so light emitted by the illuminating device 34 is transmitted through the protruding portion 32 to the user. This light conveys, to the user, information relating to an operational aspect of the cooking apparatus 10 in an optical manner from within the cooking apparatus 10 through the lenses 22. For example, the illumination device 34 can be a seven-segment display disposed within the cooking apparatus 10 to be illuminated to convey numerical information (e.g., a temperature setting on a scale from 0 to 10) relating to a corresponding cooking element 14. According to alternate embodiments, the illuminating device 34 can include a light emitting diode (“LED”) that is adjusted between on/off states to indicate whether a corresponding cooking element 14 is on or off.

During assembly of the cooking apparatus 10, an adhesive can be applied to the surface of the flange 50 or, for embodiments with a pre-applied adhesive such as the adhesive tape for example, the protective film is removed. The protruding region 32 is aligned with the aperture 24 and the lens 22 is placed in contact with the underside 26 of the body panel 12 such that the adhesive provided to the flange 50 adheres to the underside 26 of the body panel 12. The bond between the adhesive and the underside 26 of the body panel 12 promotes a water-tight seal between the lens 22 and the body panel 12, and protects against the entry of a liquid into the cooking apparatus 10 through the space 54 between the lens 22 and the body panel 12.

With the lens 22 adhered to the underside 26 of the body panel 12, the PCB 38 supporting the illuminating device 34 can then be installed. As shown in FIG. 6, the underside 26 of the body panel 12 can also optionally be provided with at least one, and optionally a plurality of brackets 58 that are welded, or otherwise secured to the body panel 12. Each bracket 58 can include an aperture 60 or other receiver that cooperates with a mechanical fastener to couple the PCB 38 to the body panel 12. For instance, the aperture 60 can be internally threaded to receiver a screw. According to alternate embodiments, a rivet can cooperate with the aperture 60 to couple the PCB 38 to the brackets 58. Alternate embodiments can utilize an adhesive or any suitable fastening system other than a mechanical fastener to couple the PCB 38 to the brackets 58 without departing from the scope of the present disclosure.

The standoffs 48 are arranged to extend between the PCB 38 and the seats 46 formed in the lenses 22 as shown in FIG. 8. Each standoff transmits a biasing force to their respective lenses 22 to urge those lenses 22 generally toward the underside 26 of the body panel 12, protecting against separation of the adhesively-coupled flange 50 from the underside 26 of the body panel 12. This biasing force is maintained by the connection between the PCB 38 and the brackets 58. As a result, the cooking apparatus 10 lacks a pre-formed, rubber gasket or a chamfer provided to the metallic trim piece or other body panel 12 to support such a gasket to protect against the intrusion of liquids into the cooking apparatus between the lens 22 and the body panel 12, where it could otherwise potentially damage the PCB 38 or circuitry provided thereto.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooking apparatus comprising:
a cooking element operable to heat a cooking vessel;
an illumination device disposed within the cooking apparatus that is to be illuminated to convey information about an operational aspect of the cooking element to a user;
a body panel defining an aperture through which light emitted by the illumination device exits the cooking apparatus; and
a lens coupled to the body panel adjacent to the aperture to interfere with entry of foreign matter into an interior of the cooking apparatus through the aperture, wherein the lens comprises:
a protruding region that extends from within the interior of the cooking apparatus at least partially into the aperture, and
a flange region that extends laterally outward, generally away from the protruding region and is coupled to an underside of the body panel.

2. The cooking apparatus of claim 1, wherein the body panel further comprises a control panel accessible to the user at the body panel and comprising an input device that is to be manipulated by a user to control operation of the cooking element.

3. The cooking apparatus of claim 1 further comprising a circuit board suspended from the body panel that supports the illumination device.

4. The cooking apparatus of claim 3 further comprising a standoff extending between the circuit board and the lens to transmitting a biasing force toward the lens to urge the lens generally toward an underside of the body panel.

5. The cooking apparatus of claim 4, wherein the circuit board supports circuitry responsive to a command entered by a user through manipulation of an input device of a control panel accessible to the user at the body panel to control operation of the cooking element.

6. The cooking apparatus of claim 1, wherein the protruding region and the flange region are integrally formed as a monolithic unit from a light-transmitting material.

7. The cooking apparatus of claim 6, wherein the light-transmitting material limits a wavelength of light emitted by the illumination device that is observable by the user externally of the cooking apparatus.

8. The cooking apparatus of claim 1, wherein the flange region comprises an adhesive on a surface of the flange region that is adhered to an underside of the body panel.

9. The cooking apparatus of claim 8, wherein the adhesive is an adhesive tape applied to the surface of the flange region that is secured to the underside of the body panel to substantially prevent a liquid entering a space between the protruding region and the aperture from entering the interior of the cooking apparatus.

10. The cooking apparatus of claim 1, wherein the protruding region extends a suitable distance from the flange region into the aperture to position an outwardly-exposed face of the protruding region flush with a surrounding portion of the body panel defining the aperture.

11. The cooking apparatus of claim 1, wherein the flange region extends entirely about a periphery of the protruding region.
